(19) United States
(12) Patent Application Publication
(10) Pub. No.: US 2013/0078940 A1
(43) Pub. Date: Mar. 28, 2013

(54) RADIO ACCESS TECHNOLOGY (RAT) BASED CALL CONTROL

(71) Applicants: Rajesh Patil, Hyderabad (IN); Asimava Bera, Hyderabad (IN); Krishna Chaitanya Pinnaka, Hyderabad (IN); Ramji Grandhi, San Diego, CA (US); Ravichandra Soordelu, San Diego, CA (US)

(72) Inventors: Rajesh Patil, Hyderabad (IN); Asimava Bera, Hyderabad (IN); Krishna Chaitanya Pinnaka, Hyderabad (IN); Ramji Grandhi, San Diego, CA (US); Ravichandra Soordelu, San Diego, CA (US)

(21) Appl. No.: 13/625,504

(22) Filed: Sep. 24, 2012

Related U.S. Application Data
(60) Provisional application No. 61/539,920, filed on Sep. 27, 2011.

(51) Int. Cl. H04W 40/02; H04W 4/22; H04W 24/00

(52) U.S. Cl. 455/404.1; 455/445; 455/423

(57) ABSTRACT

Embodiments of the present invention enable and facilitate radio access technology based call control. For example, a method for call control is described. A call request that includes a call number is received. A call type of the call request is identified based on the call number. A radio access technology associated with the call number and the call type is determined. A call is performed using the radio access technology associated with the call number and the call type. In some instances, embodiments can be used for emergency type calls. Other aspects, embodiments, and features are also claimed and described.

### RELATED APPLICATIONS AND PRIORITY CLAIM

This application is related to and claims priority from U.S. Provisional Patent Application Ser. No. 61/539,920, filed Sep. 27, 2011, for “SYSTEMS AND METHODS FOR RADIO ACCESS TECHNOLOGY BASED CALL CONTROL,” which is incorporated herein by reference.

### TECHNICAL FIELD

Embodiments of the present invention relate generally to wireless communication systems. More specifically, embodiments of the present invention relate to systems and methods for radio access technology (RAT) based call control.

### BACKGROUND

In many telecommunication systems, communications networks are used to exchange messages among several interacting spatially-separated devices. Networks may be classified according to geographic scope, which could be, for example, a metropolitan area, a local area or a personal area. Such networks would be designated respectively as a wide area network (WAN), metropolitan area network (MAN), local area network (LAN) or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet).

In some implementations, devices may provide an emergency call feature. The emergency call feature may allow the device to quickly initiate an emergency call. In some instances, the call may be placed by selecting a preconfigured menu option, by a signal generated by the pressing of a button or another control device (e.g., deployment of an air bag). To initiate such an emergency call, the device is configured to first identify the call as an emergency call type. The second step is to ensure an appropriate radio access technology exists to handle the emergency call. The second step is made difficult with the introduction of multimode wireless devices. A multimode wireless device may be configured to acquire multiple different radio access technologies. At a given moment, the device may be using one or more different technologies. Accordingly, improved systems, methods, and devices for call control, such as for emergency call control, are desirable.

### SUMMARY OF SOME EXAMPLE EMBODIMENTS

Briefly summarized below are sample embodiments of the present invention. The summaries are provided to enable a reader the ability to readily understand some aspects and features about embodiments of the present invention. The summaries shall not be utilized to constrain the full breadth of the claims.

A method for call control is described. A call request that includes a call number is received. A call type of the call request is identified based on the call number. A radio access technology associated with the call number and the call type is determined. A call is performed using the radio access technology associated with the call number and the call type.

Performing the call may include switching from a current radio access technology to the radio access technology associated with the call number and the call type. The call type of the call request may be identified using a call radio access technology lookup table. The call radio access technology lookup table may be updated by signals received from a base station. A signal identifying the radio access technology associated with the call number and the call type as being associated with the call number may be received.

It may be determined that the call has failed. It may then be determined whether there are additional radio access technologies associated with the call number and the call type. If there are additional radio access technologies associated with the call number and the call type, one of the additional radio access technologies may be acquired. The call may be performed using the acquired additional radio access technology.

The call type may be emergency. The radio access technology associated with the call number and the call type may be acquired. In one configuration, the radio access technology associated with the call number and the call type may be a currently acquired radio access technology. The method may be performed by a wireless communication device. The wireless communication device may be implemented as a receiving node. The wireless communication device may maintain call control configurations for devices that are coupled with the wireless communication device. The call request may be initiated by a user of a wireless communication device or by a machine in response to an emergency trigger.

An apparatus configured for call control is also described. The apparatus includes a processor, memory in electronic communication with the processor and instructions stored in the memory. The instructions are executable by the processor to receive a call request that comprises a call number. The instructions are also executable by the processor to identify a call type of the call request based on the call number. The instructions are further executable by the processor to determine a radio access technology associated with the call number and the call type. The instructions are also executable by the processor to perform a call using the radio access technology associated with the call number and the call type.

A wireless device configured for call control is described. The wireless device includes means for receiving a call request that comprises a call number. The wireless device also includes means for identifying a call type of the call request based on the call number. The wireless device further includes means for determining a radio access technology associated with the call number and the call type. The wireless device also includes means for performing a call using the radio access technology associated with the call number and the call type.

A computer-program product configured for call control is also described. The computer-program product includes a non-transitory computer-readable medium having instructions thereon. The instructions include code for causing a wireless device to receive a call request that includes a call number. The instructions also include code for causing the wireless device to identify a call type of the call request based on the call number. The instructions further include code for causing the wireless device to determine a radio access technology associated with the call number and the call type. The instructions also include code for causing the wireless device to perform a call using the radio access technology associated with the call number and the call type.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 shows a wireless communication system with multiple wireless devices according to embodiments of the present invention;

FIG. 2 is a block diagram illustrating various types of connectivity between a user equipment (UE) and a core network that the user equipment (UE) may utilize for data services and/or voice services;

FIG. 3 is a block diagram illustrating a call control selector for use in embodiments of the present invention;

FIG. 4 is a flow diagram of a method for call control according to some embodiments of the present invention;

FIG. 5 is a flow diagram of another method for call control according to some embodiments of the present invention;

FIG. 6 is a flow diagram of a method for call control when the wireless communication device has not yet acquired a radio access technology (RAT) according to some embodiments of the present invention;

FIG. 7 is a flow diagram of a method for determining whether an emergency call has been successfully placed according to some embodiments of the present invention; and

FIG. 8 illustrates certain components that may be included within a wireless communication device according to some embodiments of the present invention.

### DETAILED DESCRIPTION

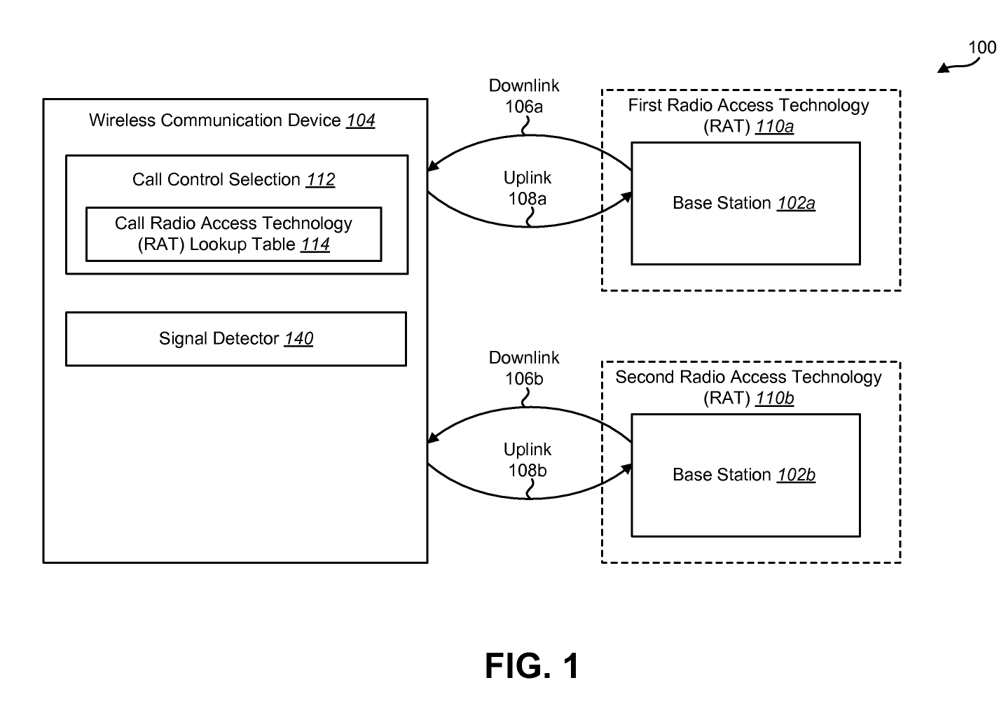

FIG. 1 shows a wireless communication system 100 with multiple wireless devices according to embodiments of the present invention. Wireless communication systems 100 are widely deployed to provide various types of communication content such as voice, data, and so on. In embodiments of the present invention, a wireless device may be a base station 102a-b or a wireless communication device 104.

A base station 102 is a station that communicates with one or more wireless communication devices 104. A base station 102 may also be referred to as, and may include some or all of the functionality of, an access point, a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless system (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink 108a-b and downlink 106a-b transmissions are on the same frequency region so that the reciprocity principle allows the estimation of the downlink 106 channel from the uplink 108 channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA, and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, a Session Initiation Protocol (SIP) phone, a wireless local loop (WLL) station, etc.

A wireless communication device 104 may communicate with zero, one or multiple base stations 102 on the downlink 106 and/or uplink 108 at any given moment. The downlink 106 (or forward link) refers to the communication link from a base station 102 to a wireless communication device 104, and the uplink 108 (or reverse link) refers to the communication link from a wireless communication device 104 to a base station 102.

One type of wireless communication system 100 is a wireless local area network (WLAN). A wireless local area network (WLAN) may be used to interconnect nearby wireless devices together, employing widely used networking protocols. The various aspects described herein may apply to any communication standard, such as wireless protocols incorporating emergency calls. A wireless communication device may connect to a base station via a Wi-Fi (e.g., an IEEE 802.11 protocol such as 802.11ah) compliant wireless link to obtain general connectivity to the internet or to other wide area networks. In one configuration, a wireless communication device 104 may be used as an access point.

A wireless communication device 104 may be capable of communicating with a first base station 102a as part of a first radio access technology (RAT) 110a and a second base station 102b as part of a second radio access technology (RAT) 110b. Examples of radio access technologies (RATs) include Global System for Mobile Communications (GSM), 1x (also known as cdma2000 1x), high data rate (HDR), W-CDMA, and Long Term Evolution (LTE). The first base station 102a may use a different radio access technology (RAT) 110 than the second base station 102b. A base station 102 and the wireless communication device 104 associated with the base station 102 may be referred to as a basic service set (BSS). The wireless communication system 100 may not have a central base station 102; instead the wireless communication system 100 may function as a peer-to-peer network between two or more wireless communication devices 104.

The wireless communication device 104 may include a call control selector 112. The call control selector 112 may control call initiation for the wireless communication device 104. For example, the call control selector 112 may identify the type of call being initiated as well as select an appropriate radio access technology (RAT) 110 for the call. When the wireless communication device 104 is implemented or used as a receiving node, the wireless communication device 104 may utilize the call control selector 112 to maintain call control configurations for devices that are coupled with the wireless communication device 104 (e.g., other wireless communication devices 104). For example, the receiving node may transmit emergency call configurations to devices within the basic service area of the receiving node.

In some implementations, a call of a particular type (such as an emergency call) may be associated with one or more categories to facilitate routing and prioritization of the call. In particular, multimode wireless communication devices 104 (such as multimode phones) may support global roaming with support of multiple radio access technologies (RATs) 110. However, emergency call control remains the property of the phone. Thus, emergency call numbers for call requests can vary with different radio access technologies (RATs) 110.

If the radio access technology (RAT) 110 is not considered by the call control selector 112, incorrect call types may be used, resulting in incorrect call handling. For example, the call may be indicated as a failure by the network due to the incorrect call type or the call may be forwarded to the wrong agency (e.g., a fire call being routed to a poison control center). Thus, the call control selector 112 needs to consider the radio access technology (RAT) 110 to ensure correct call handling.

The call control selector 112 may include a call radio access technology (RAT) lookup table 114. The call radio access technology (RAT) lookup table 114 may associate particular call numbers (i.e., numbers dialed on the wireless communication device 104) with a call type, a call category, and a radio access technology (RAT) 110. For example, the call radio access technology (RAT) lookup table 114 may associate certain call numbers with emergency calls for specific radio access technologies (RATs) 110.

Each wireless communication device 104 may maintain an emergency call category (ECC) list. An emergency call category (ECC) list may be one configuration of a call radio access technology (RAT) lookup table 114. The emergency call category (ECC) list may include emergency numbers with categories including fire, ambulance, police, etc. The emergency call category (ECC) list may be provisioned by an operator using an over-the-air (OTA) message, by original equipment manufacturers (OEMs) in the phone memory or in SIM/USIM/CSIM/RUIM cards. Thus, an emergency call category (ECC) list may be country specific (e.g., the emergency call category (ECC) list may include emergency numbers for a first country that are not applicable in a second country, even though the wireless communication device 104 can operate in both the first country and the second country).

The wireless communication device 104 may also include a signal detector 140. The signal detector 140 may detect and quantify the levels of signals received by the wireless communication device 104. For example, the signal detector 140 may detect the total energy, energy per subcarrier per symbol, and power spectral density.

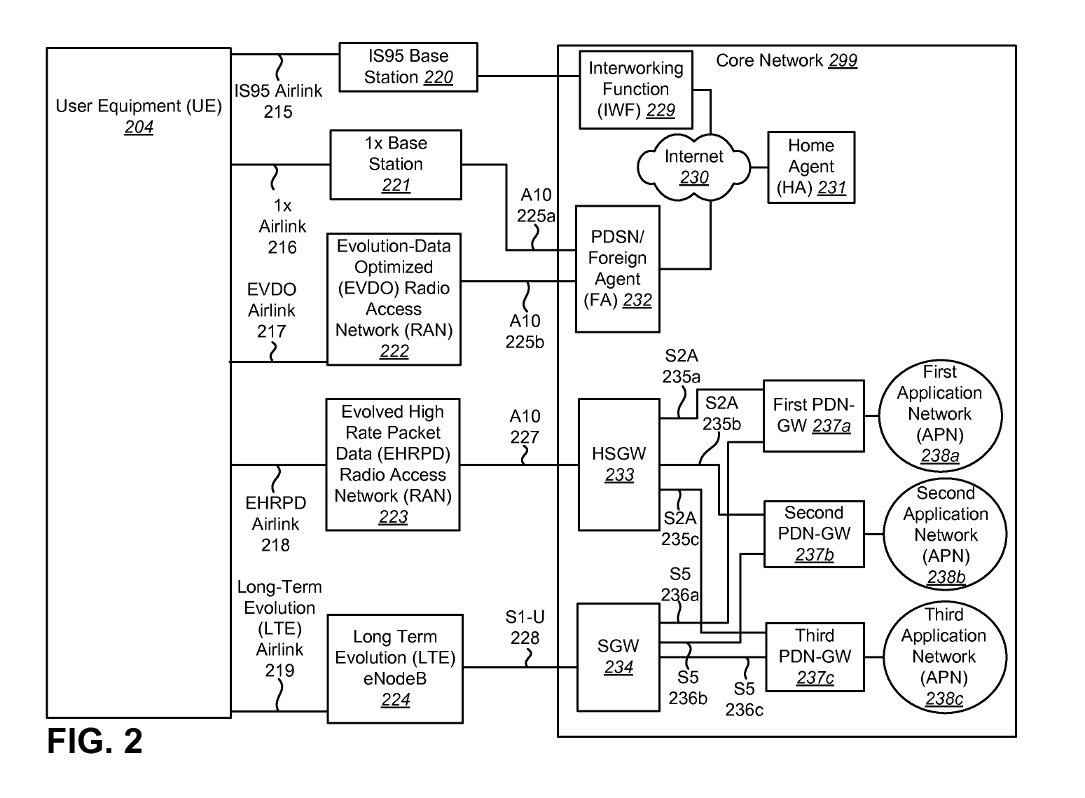

FIG. 2 is a block diagram illustrating various types of connectivity between a user equipment (UE) 204 and a core network 299 that the user equipment (UE) 204 may utilize for data services and/or voice services. The user equipment 204 of FIG. 2 may be one configuration of the wireless communication device 104 of FIG. 1. Multiple air interfaces (or airlinks) may provide a data connection for a user equipment (UE) 204 to the Internet 230 via an Interim Standard 95 (IS95u) base station 220, a CDMA 2000 1x (referred to herein as “1x”, may also be referred to as IS-2000 or 1xRTT) base station 221 and/or an Evolution-Data Optimized (EVDO) radio access network (RAN) 222. The IS95 base station 220 may provide an IS95 airlink 215 for the user equipment (UE) 204.

The IS95 base station 220 may be connected to the Internet 230 via an InterWorking Function (IWF) 229. The 1x base station 221 may provide a 1x airlink 216 to the user equipment (UE) 204. The Evolution-Data Optimized (EVDO) radio access network (RAN) 222 may provide an Evolution-Data Optimized (EVDO) airlink 217 to the user equipment (UE) 204. The 1x base station 221 and Evolution-Data Optimized (EVDO) radio access network (RAN) 222 may be connected via A10 interfaces 225a-b to a Packet Data Serving Node (PDSN) 232, which in turn is connected to the Internet 230. The Packet Data Serving Node (PDSN) 232 may include a Foreign Agent (FA). A Home Agent (HA) 231 may be connected to the Internet 230.

The network architecture may include data connectivity via the evolved high rate packet data (EHRPD) airlink 218 and an evolved high rate packet data (EHRPD) radio access network (RAN) 223 to the core network 299. The evolved high rate packet data (EHRPD) radio access network (RAN) 223 may employ an A10 interface 227 to connect to an HRPD Serving Gateway (HSGW) 233. The network architecture may also include data connectivity via the Long Term Evolution (LTE) airlink 219 and Long Term Evolution (LTE) eNodeB 224. The Long Term Evolution (LTE) eNodeB 224 may employ an S1-U interface 228 to connect to a Serving Gateway (SGW) 234. The HRPD Serving Gateway (HSGW) 233 may connect to a first Packet Data Network Gateway (PDN-GW) 237a, a second Packet Data Network Gateway (PDN-GW) 237b, and a third Packet Data Network Gateway (PDN-GW) 237c via S2A interfaces 235a-c.

The Serving Gateway (SGW) 234 may connect with the first Packet Data Network Gateway (PDN-GW) 237a, the second Packet Data Network Gateway (PDN-GW) 237b, and the third Packet Data Network Gateway (PDN-GW) 237c via S5 interfaces 236a-c. The first Packet Data Network Gateway (PDN-GW) 237a may connect to a first Application Network (APN) 238a. The second Packet Data Network Gateway (PDN-GW) 237b may connect to a second Application Network (APN) 238b. The third Packet Data Network Gateway (PDN-GW) 237c may connect to a third Application Network (APN) 238c. An Application Network (APN) 238 may include, but is not limited to, an Internet Multimedia System (IMS) that a user equipment (UE) 204 connects to for obtaining Voice over IP (VoIP) or video telephony services or an Administrative Application Network (APN) the user equipment (UE) 204 may establish a connection with in order to download configuration information for the user equipment (UE) 204.

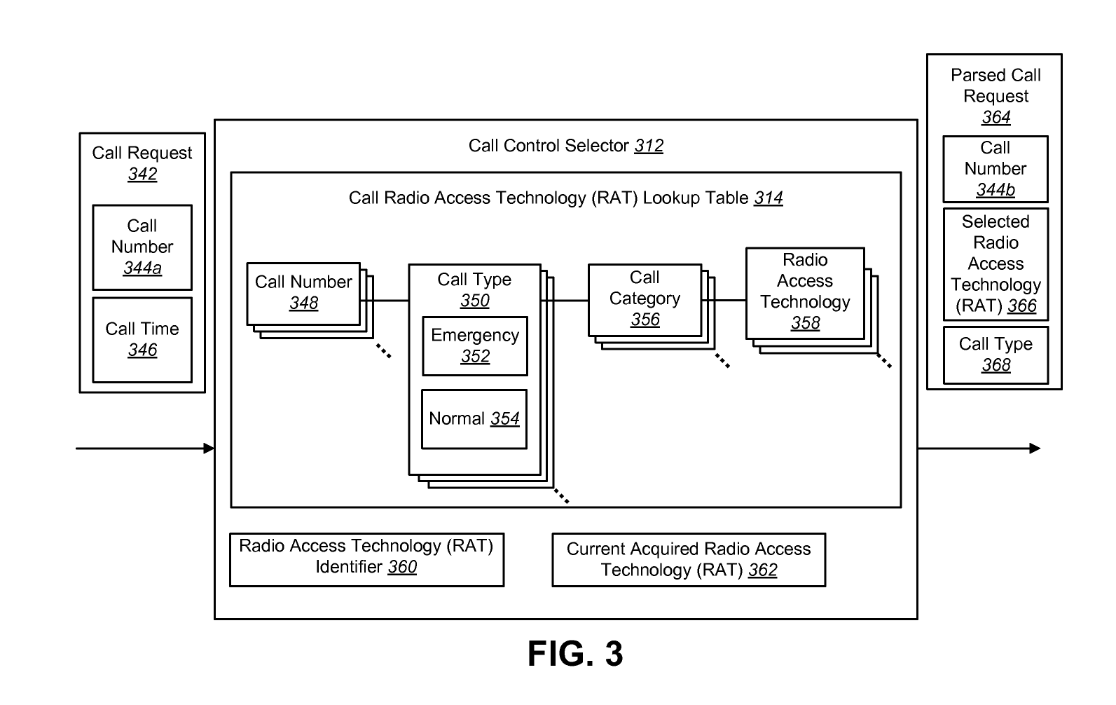

FIG. 3 is a block diagram illustrating a call control selector 312 for use in embodiments of the present invention. The call control selector 312 of FIG. 3 may be one configuration of the call control selector 112 of FIG. 1. The call control selector 312 may include a call radio access technology (RAT) lookup table 314. As discussed above, different call numbers 348 may be associated with different radio access technologies (RATs) 358. One particular example is emergency calls. An emergency call category (ECC) list may be a specific example of a call radio access technology (RAT) lookup table 314. The call radio access technology (RAT) lookup table 314 may be updated by signals from a base station 102. In one configuration, the call control selector 312 may retrieve pre-loaded call control information from memory (such as from a SIM card)

The call radio access technology (RAT) lookup table 314 may link a call number 348 (the destination number) to a call type 350, a call category 356, and a radio access technology (RAT) 358. The call type 350 may be emergency 352 or normal 354. In some implementations, an emergency call may be associated with one or more different call categories 356 to facilitate routing and prioritization of the emergency call to the appropriate responders. One example of a call radio access technology (RAT) lookup table 314 for emergency calls is given below in Table 1.

TABLE 1

| Emergency Call | Emergency Call | Radio Access Technology |
|---|---|---|
| Number | Category | (RAT) |
| 911 | 4 | GSM/WCDMA |
| 112 | 4 | GSM/WCDMA |
| 000 | 4 | GSM/WCDMA |
| 08 | 3 | GSM/WCDMA |
| 110 | 4 | GSM/WCDMA |
| 999 | 4 | GSM/WCDMA |
| 118 | 4 | GSM/WCDMA |
| 119 | 4 | GSM/WCDMA |
| 911 | 4 | 1x |
| #911 | 5 | 1x |
| *911 | 5 | 1x |
| 911 | 4 | LTE |
| #911 | 5 | LTE |
| *911 | 5 | LTE |

In Table 1, an emergency call category 356 of “3” refers to “police and ambulance,” an emergency call category 356 of “4” refers to “fire brigade” and an emergency call category 356 of “5” refers to “fire brigade and police.” The call control selector 312 may receive a call request 342. A call request 342 may be initiated by a user of the wireless communication device 104 or by a trigger (such as an airbag deploying). The call request 342 may include a call number 344a and a call time 346. In one configuration, the call request 342 may have a call type 350 of emergency 352.

The call control selector 312 may include a radio access technology (RAT) identifier 360. The radio access technology (RAT) identifier 360 may search the call radio access technology (RAT) lookup table 314 to determine whether the call request 342 has a call type 350 that is emergency 352 or normal 354 (i.e., by determining the call type 350, call category 356, and radio access technology (RAT) 358 associated with the call number 348 in the call radio access technology (RAT) lookup table 314). In one configuration, if the call number 344a is not identified by the radio access technology (RAT) identifier 360, the call request 342 may be considered a normal 354 or non-emergency call. The call control selector 312 may also include a listing of the current acquired radio access technology (RAT) 362.

The call control selector 312 may output a parsed call request 364. The parsed call request 364 may be provided to other modules/hardware components within the wireless communication device 104. For example, the parsed call request 364 may be provided to a processor or a transmitter. The parsed call request 364 may include the call number 344b, a selected radio access technology (RAT) 366, and a call type 368. In some configurations, the selected radio access technology (RAT) 366 may be dependent on the current acquired radio access technology (RAT) 362. The wireless communication device 104 may then use the parsed call request 364 to attempt/perform the call using the appropriate call category 356 and radio access technology (RAT) 366.

If the appropriate radio access technology (RAT) 366 and/or call type 350 for a given call request 342 is not used, the call request 342 may fail. For example, if the call number 344a is “08” from Table 1 above and the current acquired radio access technology (RAT) 362 is LTE, the call may fail if the wireless communication device 104 attempts to place an emergency call to the call number “08” on the LTE network (because “08” is not a recognized emergency call number for LTE). The LTE network may also attempt to place the call as a normal 354 call, which may result in a failure because “08” may be an unidentified call number 344a. By using the call radio access technology (RAT) lookup table 314, the call control selector 312 may properly identify the call number 344a “08” as an emergency call for GSM/WCDMA. The call control selector 312 may then use GSM/WCDMA as the selected radio access technology (RAT) 366 in the parsed call request 364.

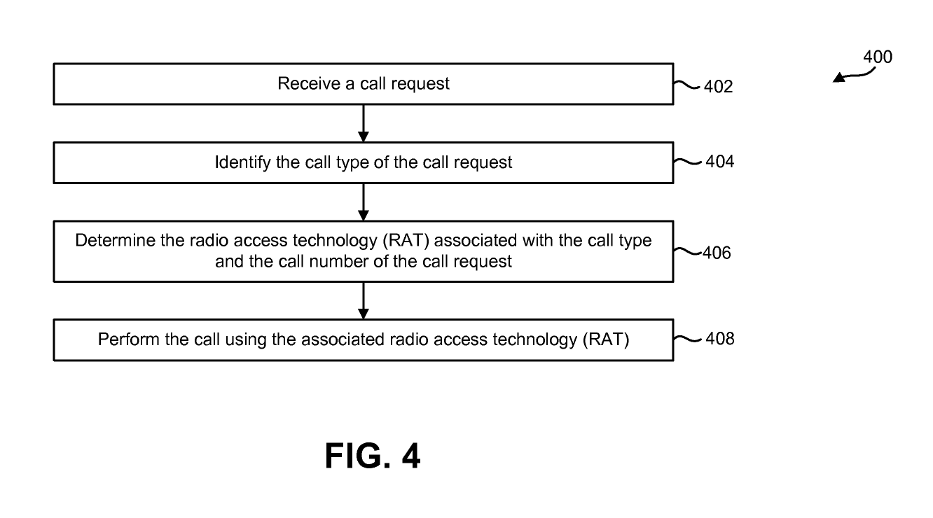

FIG. 4 is a flow diagram of a method 400 for call control. The method 400 may be performed by a wireless communication device 104. The wireless communication device 104 may include a call control selector 112. The call control may be for emergency call category (ECC) calls.

The wireless communication device 104 may receive 402 a call request 342. The call request 342 may be received 402 from a user of the wireless communication device 104 or triggered by a machine (such as a smoke detector) in response to an emergency trigger (such as detecting smoke). The wireless communication device 104 may identify 404 the call type 350 of the call request 342. For example, the wireless communication device 104 may identify 404 the call type 350 of the call request 342 as either emergency 352 or normal 354. Identifying 404 the call type 350 may include receiving the call type 350 in response to a network call (e.g., looking the call type 350 up via a web service) or obtaining the call type 350 from memory.

The wireless communication device 104 may also determine 406 the radio access technology (RAT) 358 associated with the call type 350 and the call number 344a of the call request 342. In one configuration, the wireless communication device 104 may determine 406 the radio access technology (RAT) 358 using a call radio access technology (RAT) lookup table 314. The wireless communication device 104 may then perform 408 the call using the associated radio access technology (RAT) 358.

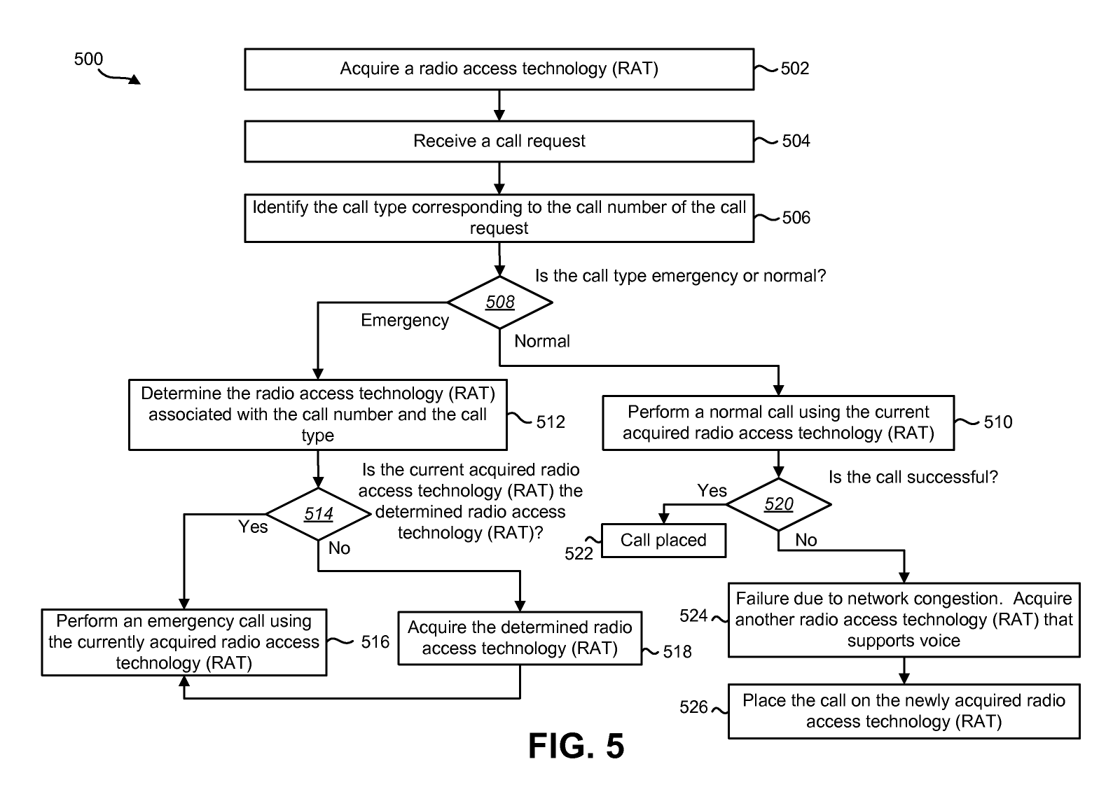

FIG. 5 is a flow diagram of another method 500 for call control. The method 500 may be performed by a wireless communication device 104. The wireless communication device 104 may include a call control selector 112. The call control may be for emergency call category (ECC) calls.

The wireless communication device 104 may acquire 502 a radio access technology (RAT) 110. The radio access technology (RAT) 110 may be the currently acquired radio access technology (RAT) 362. The wireless communication device 104 may receive 504 a call request 342. The wireless communication device 104 may identify 506 the call type 350 corresponding to the call number 344a of the call request 342. As discussed above, the wireless communication device 104 may identify 506 the call type 350 corresponding to the call number 344a of the call request 342 using a call radio access technology (RAT) lookup table 314.

The wireless communication device 104 may determine 508 whether the call type 350 is emergency 352 or normal 354. For example, if the call number 344a is “456,” using the example call radio access technology (RAT) lookup table 314 illustrated above in Table 1, the call number 344a is not an emergency 352 call. If the call type 350 is normal 354, the wireless communication device 104 may perform 510 a normal call using the current acquired radio access technology (RAT) 362. There may be more call types 350 than emergency 352 and normal 354. For example, a subsequent listing of call number 344a attributes may occur to further identify the call type 350 corresponding to the call number 344a.

The wireless communication device 104 may determine 530 whether the call is successful. If the call is successful, then the call has been placed 522. If the call is not successful, then the failure is due to network congestion. The wireless communication device 104 may acquire 524 another radio access technology (RAT) 358 that supports voice. The wireless communication device 104 may then place 526 the call on the newly acquired radio access technology (RAT) 358.

If the call type 350 is emergency 352, the wireless communication device 104 may determine 512 the radio access technology (RAT) 358 associated with the call number 348 and the call type 350. The wireless communication device 104 may determine 512 the radio access technology (RAT) 358 associated with the call number 348 and the call type 350 using the call radio access technology (RAT) lookup table 314.

The wireless communication device 104 may determine 514 whether the determined radio access technology (RAT) 358 is the current acquired radio access technology (RAT) 362. If the determined radio access technology (RAT) 358 is the current acquired radio access technology (RAT) 362, the wireless communication device 104 may perform 516 an emergency call using the current acquired radio access technology (RAT) 362. If the determined radio access technology (RAT) 358 is not the current acquired radio access technology (RAT) 362, the wireless communication device 104 may acquire 518 the determined radio access technology (RAT) 358. The wireless communication device 104 may then perform 516 an emergency call using the current acquired radio access technology (RAT) 362.

For example, the call number 344a may be “08” and the currently acquired radio access technology (RAT) 362 may be CDMA/1x. Since the call number 344a “08” is associated with GSM/WCDMA in the call radio access technology (RAT) lookup table 314, and not with CDMA/1x, the wireless communication device 104 may attempt to find a GSM/WCDMA radio access technology (RAT) 110 prior to placing the emergency call.

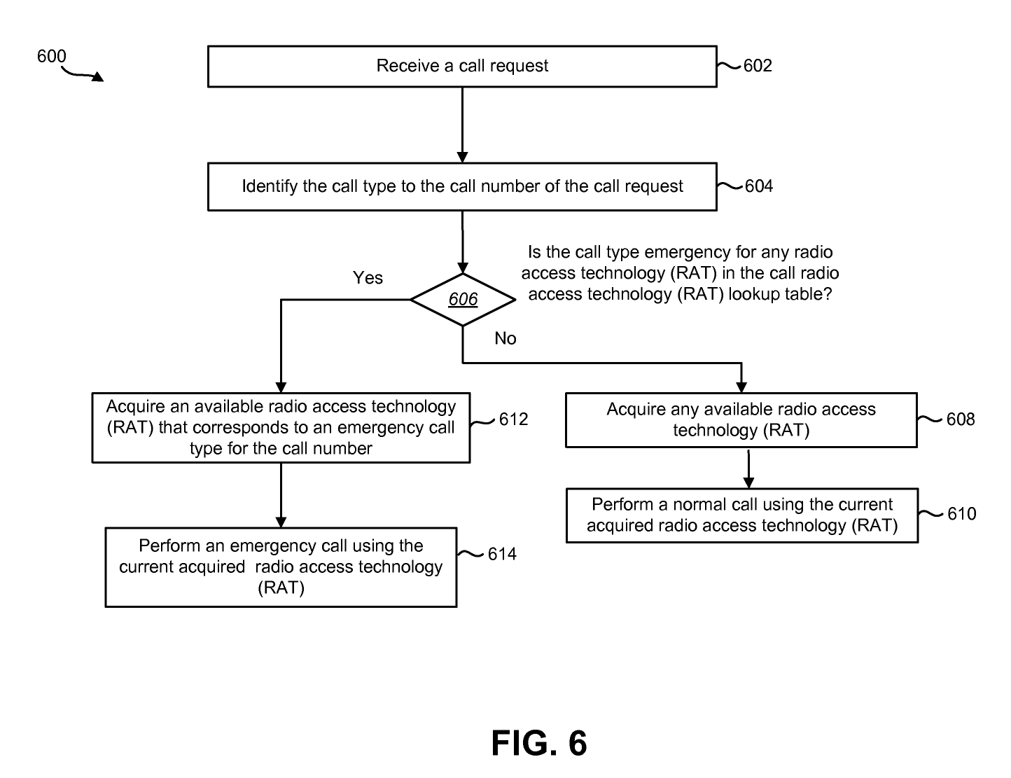

FIG. 6 is a flow diagram of a method 600 for call control when the wireless communication device 104 has not yet acquired a radio access technology (RAT) 110. The method 600 may be performed by the wireless communication device 104. The wireless communication device 104 may include a call control selector 112. The wireless communication device 104 may receive 602 a call request 342. As discussed above, the call request 342 may be received from a user of the wireless communication device 104 or from a machine (such as an alarm system in a home).

The wireless communication device 104 may identify 604 the call type 350 corresponding to the call number 344a of the call request 342. The wireless communication device 104 may determine 606 whether the call type 350 is emergency 352 for any radio access technology (RAT) 358 in the call radio access technology (RAT) lookup table 314. If the call type 350 is not emergency 352 for any radio access technology (RAT) 358 in the call radio access technology (RAT) lookup table 314, the wireless communication device 104 may acquire 608 any available radio access technology (RAT) 110. The wireless communication device 104 may then perform 610 a normal call using the current acquired radio access technology (RAT) 362.

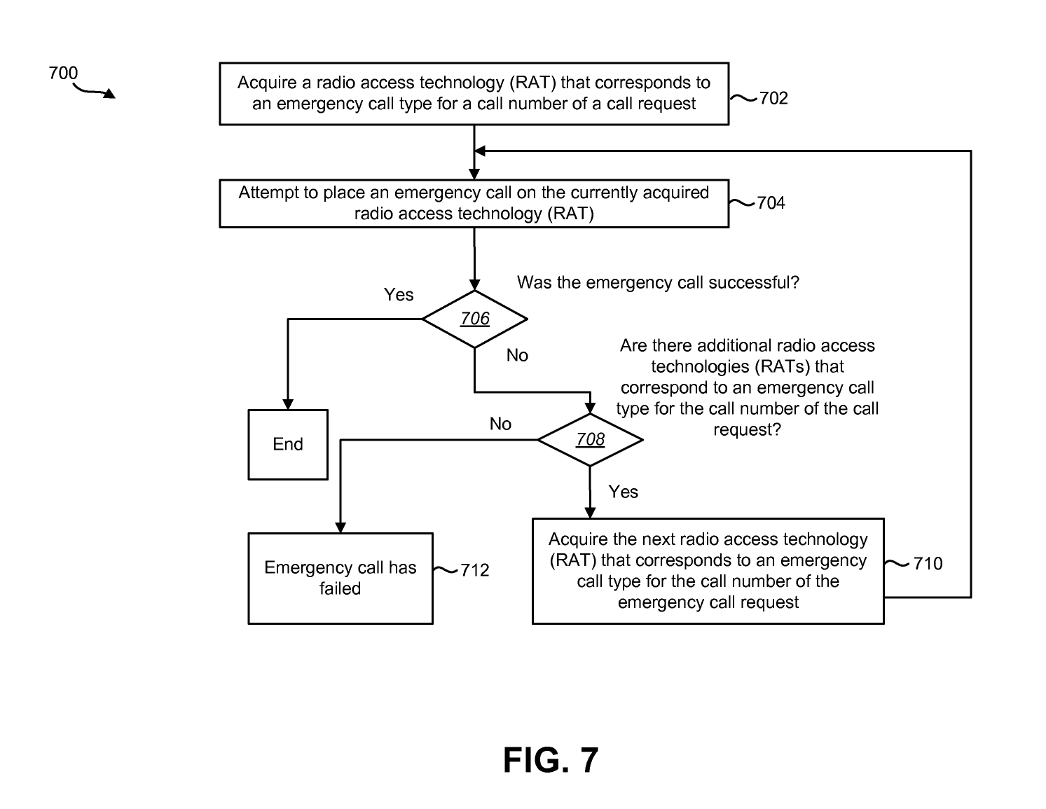

If the call type 350 is emergency 352 for any radio access technology (RAT) 358 in the call radio access technology (RAT) lookup table 314, the wireless communication device 104 may acquire 612 an available radio access technology (RAT) 110 that corresponds to an emergency 352 call type 350 for the call number 348. If there are multiple available radio access technologies (RATs) 110 that correspond to an emergency 352 call type 350 for the call number 348, the wireless communication device 104 may pick an available radio access technology (RAT) 110 with a highest priority or an available radio access technology (RAT) 110 that the wireless communication device 104 was most recently connected to. Once the wireless communication device 104 has acquired 612 an available radio access technology (RAT) 110, the wireless communication device 104 may perform 614 an emergency call using the current acquired radio access technology (RAT) 362. Failure to acquire a radio access technology (RAT) 110 is discussed in additional detail below in relation to FIG. 7.

FIG. 7 is a flow diagram of a method 700 for determining whether an emergency call has been successfully placed. The method 700 may be performed by a wireless communication device 104. The wireless communication device 104 may include a call control selector 112. The wireless communication device 104 may acquire 702 a radio access technology (RAT) 110 that corresponds to an emergency 352 call type 350 for a call number 344a of a call request 342.

The wireless communication device 104 may attempt 704 to place an emergency call on the currently acquired radio access technology (RAT) 362. The wireless communication device 104 may determine 706 whether the emergency call was successful. If the emergency call was successful, then the method 700 may end. If the emergency call was not successful, the wireless communication device 104 may determine 708 whether there are additional radio access technologies (RATs) 110 that correspond to an emergency 352 call type 350 for the call number 344a of the call request 342. If there are additional radio access technologies (RATs) 110 that correspond to an emergency 352 call type 350 for the call number 344a of the call request 342, the wireless communication device 104 may acquire 710 the next radio access technology (RAT) 110 that corresponds to an emergency 352 call type 350 for the call number 344a of the emergency call request 342. The wireless communication device 104 may then attempt 704 to place an emergency call on the currently acquired radio access technology (RAT) 362. If there are not additional radio access technologies (RATs) 110 that correspond to an emergency 352 call type 350 for the call number 344a of the call request 342, the emergency call has failed 712.

As an example, the call number 344a “911” is associated with three radio access technologies (RATs) (GSM/WCDMA, 1x and LTE) in Table 1. If the emergency call fails over GSM/WCDMA, the wireless communication device 104 may next attempt the emergency call over 1x or LTE. The method may continue until all associated radio access technologies (RATs) 110 have been attempted.

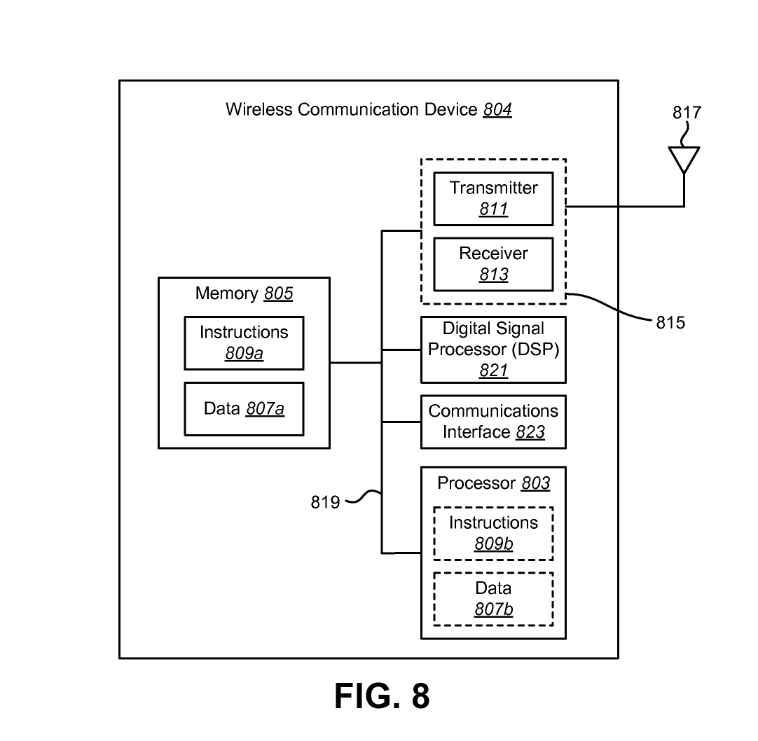

FIG. 8 illustrates certain components that may be included within a wireless communication device 804. The wireless communication device 804 may be an access terminal, a mobile station, a user equipment (UE), etc. The wireless communication device 804 includes a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the wireless communication device 804 of FIG. 8, in an alternative configuration, a combination of processors 803 (e.g., a general purpose CPU and digital signal processor (DSP)) could be used.

The wireless communication device 804 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809a, various portions of the instructions 809b may be loaded onto the processor 803, and various pieces of data 807b may be loaded onto the processor 803.

The wireless communication device 804 may also include a transmitter 811 and a receiver 813 to allow transmission and reception of signals to and from the wireless communication device 804. The transmitter 811 and receiver 813 may be collectively referred to as a transceiver 815. An antenna 817 may be electrically coupled to the transceiver 815. The wireless communication device 804 may also include (not shown) multiple transmitters, multiple receivers, multiple transceivers and/or multiple antennas.

The wireless communication device 804 may include a digital signal processor (DSP) 821. The wireless communication device 804 may also include a communications interface 823. The communications interface 823 may allow a user to interact with the wireless communication device 804.

The various components of the wireless communication device 804 may be coupled together by one or more buses 819, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4-7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

We claim:

1. A method for call control, comprising:
receiving a call request that comprises a call number;
identifying a call type of the call request based on the call number;
determining a radio access technology associated with the call number and the call type; and
performing a call using the radio access technology associated with the call number and the call type.

2. The method of claim 1, wherein performing the call comprises switching from a current radio access technology to the radio access technology associated with the call number and the call type.

3. The method of claim 1, wherein the call type of the call request is identified using a call radio access technology lookup table.

4. The method of claim 3, wherein the call radio access technology lookup table is updated by signals received from a base station.

5. The method of claim 1, further comprising receiving a signal identifying the radio access technology associated with the call number and the call type as being associated with the call number.

6. The method of claim 1, further comprising:
determining that the call has failed; and
determining whether there are additional radio access technologies associated with the call number and the call type.

7. The method of claim 6, wherein there are additional radio access technologies associated with the call number and the call type, and further comprising;
acquiring one of the additional radio access technologies; and
performing the call using the acquired additional radio access technology.

8. The method of claim 1, wherein the call type is emergency.

9. The method of claim 1, further comprising acquiring the radio access technology associated with the call number and the call type.

10. The method of claim 1, wherein the radio access technology associated with the call number and the call type is a currently acquired radio access technology.

11. The method of claim 1, wherein the method is performed by a wireless communication device.

12. The method of claim 11, wherein the wireless communication device is implemented as a receiving node, and wherein the wireless communication device maintains call control configurations for devices that are coupled with the wireless communication device.

13. The method of claim 1, wherein the call request is initiated by a user of a wireless communication device.

14. The method of claim 1, wherein the call request is initiated by a machine in response to an emergency trigger.

15. An apparatus configured for call control, comprising:
a processor;
memory in electronic communication with the processor; and
instructions stored in the memory, the instructions being executable by the processor to:
receive a call request that comprises a call number;
identify a call type of the call request based on the call number;
determine a radio access technology associated with the call number and the call type; and
perform a call using the radio access technology associated with the call number and the call type.

16. The apparatus of claim 15, wherein the instructions executable to perform the call comprise instructions executable to switch from a current radio access technology to the radio access technology associated with the call number and the call type.

17. The apparatus of claim 15, wherein the call type of the call request is identified using a call radio access technology lookup table.

18. The apparatus of claim 17, wherein the call radio access technology lookup table is updated by signals received from a base station.

19. The apparatus of claim 15, wherein the instructions are further executable to receive a signal identifying the radio access technology associated with the call number and the call type as being associated with the call number.

20. The apparatus of claim 15, wherein the instructions are further executable to:
determine that the call has failed; and
determine whether there are additional radio access technologies associated with the call number and the call type.

21. The apparatus of claim 20, wherein there are additional radio access technologies associated with the call number and the call type, and wherein the instructions are further executable to;
acquire one of the additional radio access technologies; and
perform the call using the acquired additional radio access technology.

22. The apparatus of claim 15, wherein the call type is emergency.

23. The apparatus of claim 15, wherein the instructions are further executable to acquire the radio access technology associated with the call number and the call type.

24. The apparatus of claim 15, wherein the radio access technology associated with the call number and the call type is a currently acquired radio access technology.

25. The apparatus of claim 15, wherein the apparatus is a wireless communication device.

26. The apparatus of claim 25, wherein the wireless communication device is implemented as a receiving node, and wherein the wireless communication device maintains call control configurations for devices that are coupled with the wireless communication device.

27. The apparatus of claim 15, wherein the call request is initiated by a user of a wireless communication device.

28. The apparatus of claim 15, wherein the call request is initiated by a machine in response to an emergency trigger.

29. A wireless device configured for call control, comprising:
means for receiving a call request that comprises a call number;
means for identifying a call type of the call request based on the call number;
means for determining a radio access technology associated with the call number and the call type; and
means for performing a call using the radio access technology associated with the call number and the call type.

30. The wireless device of claim 29, wherein the means for performing the call comprise means for switching from a current radio access technology to the radio access technology associated with the call number and the call type.

31. The wireless device of claim 29, wherein the call type of the call request is identified using a call radio access technology lookup table.

32. A computer-program product configured for call control, the computer-program product comprising a non-transitory computer-readable medium having instructions thereon, the instructions comprising:
code for causing a wireless device to receive a call request that comprises a call number;
code for causing the wireless device to identify a call type of the call request based on the call number;
code for causing the wireless device to determine a radio access technology associated with the call number and the call type; and
code for causing the wireless device to perform a call using the radio access technology associated with the call number and the call type.

33. The computer-program product of claim 32, wherein the code for causing the wireless device to perform the call comprise code for causing the wireless device to switch from a current radio access technology to the radio access technology associated with the call number and the call type.

34. The computer-program product of claim 32, wherein the call type of the call request is identified using a call radio access technology lookup table.
